(19) United States
(12) Patent Application Publication
(10) Pub. No.: US 2022/0187465 A1
(43) Pub. Date: Jun. 16, 2022

(54) OPTICAL SWITCHABLE DEPTH SENSING CAMERA

(71) Applicant: iSSA Technology Co., Ltd., Taoyuan City (TW)

(72) Inventor: Chi-Wei CHIU, Taoyuan City (TW)

(21) Appl. No.: 17/211,221

(22) Filed: Mar. 24, 2021

(30) Foreign Application Priority Data
Dec. 16, 2020 (TW) 109144422

(51) Int. Cl. G01S 17/894; G02B 7/14; G01S 17/42; H04N 5/33

(52) U.S. Cl. CPC G01S 17/894; H04N 5/33; G01S 17/42; G02B 7/14

(57) ABSTRACT

An optical switchable depth sensing camera includes an infrared laser module, an image sensor, a first optical lens, a second optical lens, a switching mechanism, and a microcontroller. The image sensor receives an infrared laser outputted from the infrared laser module. The first optical lens is fixed on the image sensor. The second optical lens is removably disposed on the first optical lens. The switching mechanism is coupled to the second optical lens and controls a position of the second optical lens.

### BACKGROUND

### Technical Field

The present disclosure relates to a depth sensing camera, and more particularly to an optical switchable depth sensing camera combining multiple switchable lenses and a single image sensor.

### Description of Related Art

The statements in this section merely provide background information related to the present disclosure and do not necessarily constitute prior art.

As smart apparatuses become more widely used, modern people apply more and more personal information to digital products with electronic transmission functions. For example, smart phones and computers that are now quite popular. In order to better protect personal information and prevent private content from being snooped or stolen by others, various manufacturers are actively developing various digital anti-theft solutions. While augmented reality (AR) is also booming, face recognition with 3D sensing technology will become a potential solution with personal privacy protection. The 3D sensing technology can not only be applied to face recognition with portable digital products, but also can be further used for geo-detection and enhancement of 3D model building.

Therefore, ordinary 3D sensing technology uses a fixed optical solution, that is, only an optical lens with a fixed focal length and a fixed field-of-view (FOV) for a single image sensor. For example, when performing face recognition on a stationary target, an optical lens with a fixed focal length and a FOV can meet the requirements. However, for non-stationary target with complex structures or moving relative to the image sensor, it is easy to cause out of the focal range or the FOV of the optical lens due to the target has moved too far. It not only causes troubles in sensing, but also easily produces severely distorted sensing results.

Therefore, how to design an optical switchable depth sensing camera, and more particularly to solve the aforementioned technical problems in the prior art, was studied by inventor of the present disclosure.

### SUMMARY

First purpose of the present disclosure is to provide an optical switchable depth sensing camera, which can solve the prior art technical problems about non-stationary target with complex structures or moving relative to the image sensor is easy to cause out of the focal range or the FOV of the optical lens due to the target has moved too far, so as to achieve the first purpose of convenient to operate and to use.

In order to achieve the first purpose, the optical switchable depth sensing camera of the present disclosure includes an infrared laser module, an image sensor, a first optical lens, a second optical lens, a switching mechanism, and a microcontroller. The infrared laser module outputs an infrared laser. The image sensor receives the infrared laser. The first optical lens is fixed on the image sensor. The second optical lens is removably disposed on the first optical lens. The switching mechanism is coupled to the second optical lens and controlled a position of the second optical lens. The microcontroller is coupled to the image sensor, the switching mechanism and the infrared laser module.

Further, the infrared laser module includes a first light-emitting unit and a second light-emitting unit, the first light-emitting unit outputs at least part of the infrared laser when the second optical lens is not above the first optical lens, and the second light-emitting unit outputs at least part of the infrared laser when the second optical lens is above the first optical lens.

Further, the microcontroller obtains a time-of-flight (ToF) data through the image sensor, the microcontroller controls a modulation frequency and a power of the infrared laser outputted from the infrared laser module according to the ToF data.

Further, the switching mechanism includes at least one of a stepping motor, a servo motor, and a linear actuator.

Further, a focal length of the first optical lens is larger than a focal length of the second optical lens, and a field-of-view (FOV) of the first optical lens is smaller than a FOV of the second optical lens.

Further, a focal length of the first optical lens is between 2 meters and 30 meters, and a focal length of the second optical lens is between 15 centimeters and 3 meters.

Second purpose of the present disclosure is to provide an optical switchable depth sensing camera, which can solve the prior art technical problems about non-stationary target with complex structures or moving relative to the image sensor is easy to cause out of the focal range or the FOV of the optical lens due to the target has moved too far, so as to achieve the second purpose of convenient to operate and to use.

In order to achieve the second purpose, the optical switchable depth sensing camera of the present disclosure includes an optical module, an infrared laser module, an image sensor, and a microcontroller. The optical module includes a switching mechanism, a first optical lens, and a second optical lens, the switching mechanism is coupled to at least one of the first optical lens and the second optical lens, and controls a position of the first optical lens and a position of the second optical lens. The infrared laser module outputs an infrared laser. The image sensor receives the infrared laser, and the first optical lens or the second optical lens is removably disposed on the image sensor. The microcontroller is coupled to the image sensor, the switching mechanism and the infrared laser module.

Further, the infrared laser module includes a first light-emitting unit and a second light-emitting unit, the first light-emitting unit outputs at least part of the infrared laser when the first optical lens is above the image sensor, and the second light-emitting unit outputs at least part of the infrared laser when the second optical lens is above the image sensor.

Further, the microcontroller obtains a ToF data through the image sensor, the microcontroller controls a modulation frequency and a power of the infrared laser outputted from the infrared laser module according to the ToF data.

Further, the switching mechanism includes at least one of a stepping motor, a servo motor, and a linear actuator.

Further, a focal length of the first optical lens is larger than a focal length of the second optical lens, and a FOV of the first optical lens is smaller than a FOV of the second optical lens.

Further, a focal length of the first optical lens is between 2 meters and 30 meters, and a focal length of the second optical lens is between 15 centimeters and 3 meters.

When using any optical switchable depth sensing camera of the present disclosure, the infrared laser module outputs the infrared laser to an area to be measured, and the image sensor receives the infrared laser reflected from the area to be measured through at least one of the first optical lens and the second optical lens. Further, the microcontroller can obtain the ToF data including detecting depth information through a method of ToF applying the image sensor, so that the microcontroller can obtain 3D state of the area to be measured. And, while the microcontroller is performing the method of ToF, the switching mechanism can be used to determine whether the first optical lens or the second optical lens is located on an optical axis of the image sensor, so that the microcontroller can quickly know a distance between the image sensor and the area to be measured. The microcontroller can immediately control the position of the first optical lens and the second optical lens according to a distance continuously updated between the image sensor and the target. The focal length and FOV of at least one of the first optical lens and the second optical lens can correctly correspond to the area to be measured, so that the image sensor can obtain a complete (the FOV of image sensor can cover the area to be measured) and clear (the distance between the image sensor and the area to be measured matches the focal length of the image sensor) image.

For this reason, the present disclosure can solve the prior art technical problems about non-stationary target with complex structures or moving relative to the image sensor is easy to cause out of the focal range or the FOV of the optical lens due to the target has moved too far, so as to achieve purposes of convenient to operate and to use.

In order to further understand the techniques, means, and effects of the present disclosure for achieving the intended purpose. Please refer to the following detailed description and drawings of the present disclosure. The drawings are provided for reference and description only, and are not intended to limit the present disclosure.

### BRIEF DESCRIPTION OF DRAWINGS

FIG. 1 is a schematic diagram of the appearance of an optical switchable depth sensing camera of the present disclosure.

FIG. 2 is an exploded schematic diagram of the optical switchable depth sensing camera of the present disclosure.

FIG. 3 and FIG. 4 are schematic diagrams of a narrow-angle telephoto mode of the optical switchable depth sensing camera of the present disclosure.

FIG. 5 and FIG. 6 are schematic diagrams of a wide-angle short-focus mode of the optical switchable depth sensing camera of the present disclosure.

FIG. 7 and FIG. 8 are schematic diagrams of an optical module of the optical switchable depth sensing camera of the present disclosure.

FIG. 9 is a schematic diagram of the determination flow of a switching mechanism of the optical switchable depth sensing camera of the present disclosure.

### DETAILED DESCRIPTION

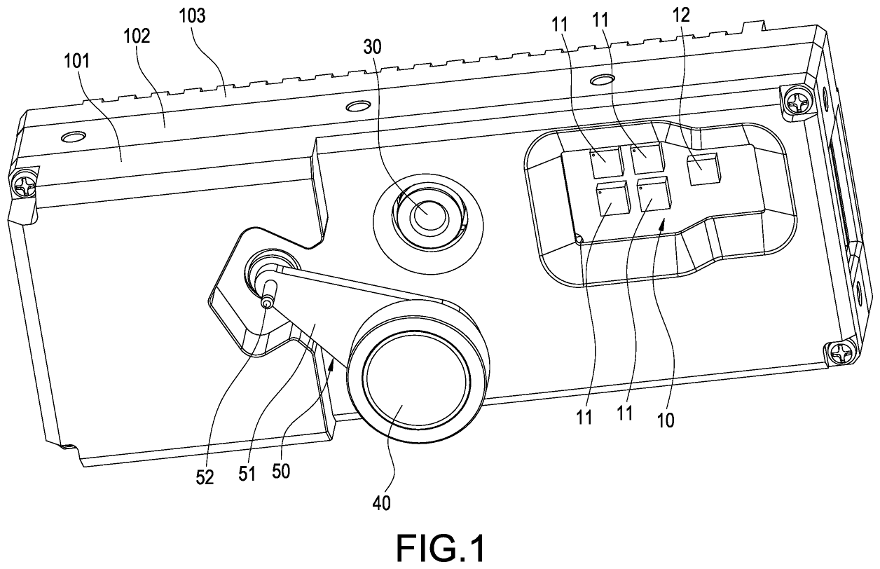

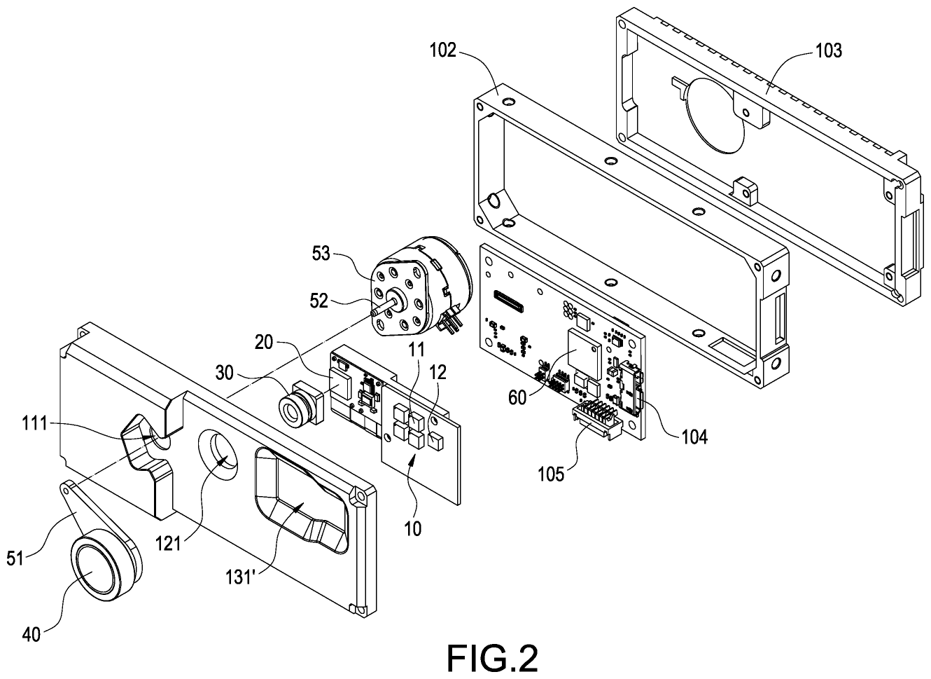

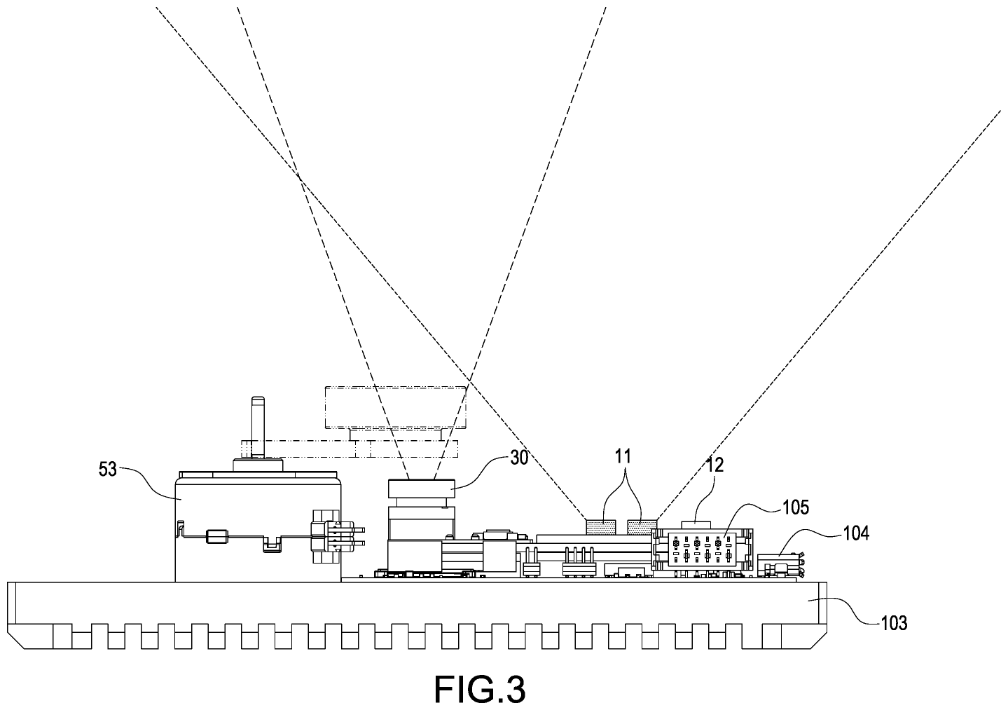

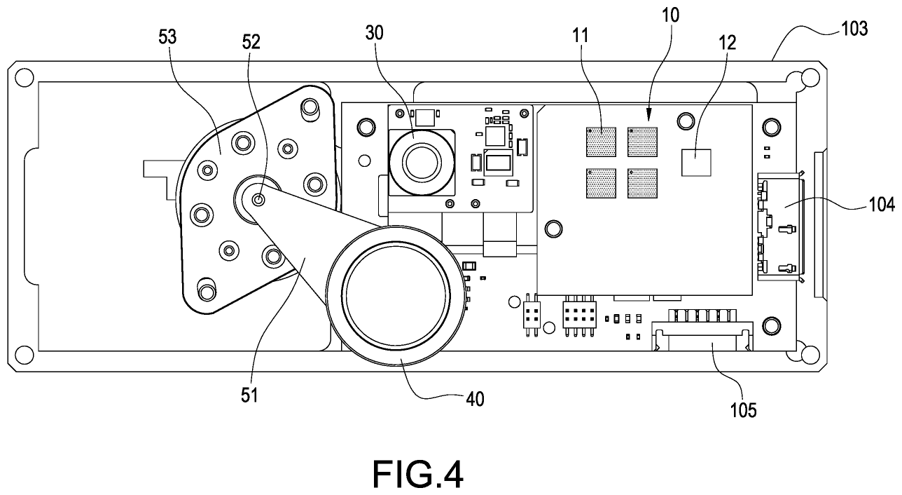

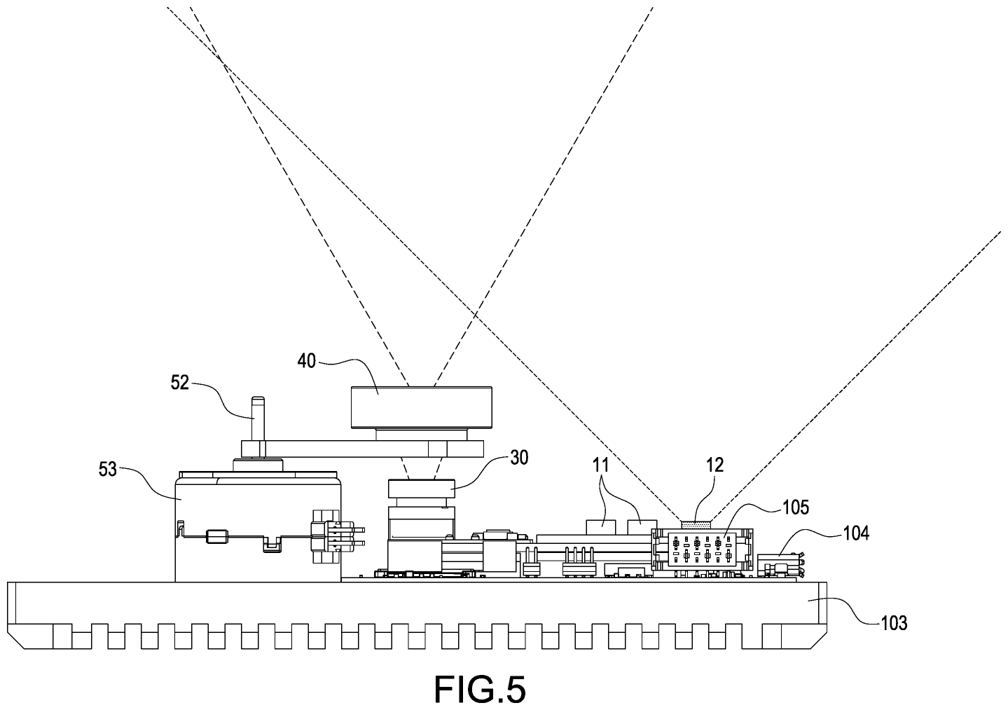

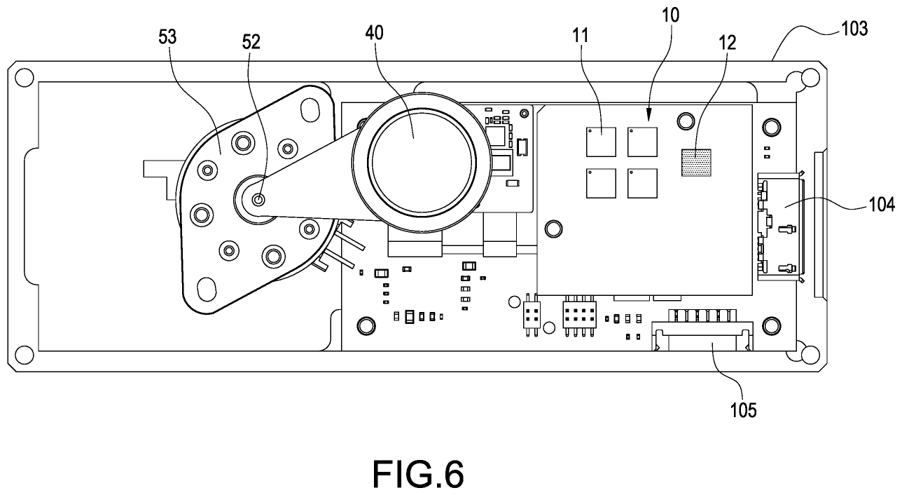

The technical content and detailed description of the present disclosure will be described below in conjunction with the drawings. Please refer to FIG. 1 to FIG. 6. FIG. 1 is a schematic diagram of the appearance of an optical switchable depth sensing camera of the present disclosure. FIG. 2 is an exploded schematic diagram of the optical switchable depth sensing camera of the present disclosure. FIG. 3 and FIG. 4 are schematic diagrams of a narrow-angle telephoto mode of the optical switchable depth sensing camera of the present disclosure. FIG. 5 and FIG. 6 are schematic diagrams of a wide-angle short-focus mode of the optical switchable depth sensing camera of the present disclosure.

In a first embodiment of the present disclosure, the optical switchable depth sensing camera of the present disclosure may include an infrared laser module 10, an image sensor 20, a first optical lens 30, a second optical lens 40, a switching mechanism 50, and a microcontroller 60. The infrared laser module 10 outputs an infrared laser (IR laser). The image sensor 20 receives the infrared light laser. The first optical lens 30 is fixed on the image sensor 20. The second optical lens 40 is removably disposed on the first optical lens 30. The switching mechanism 50 is coupled to the second optical lens 40 and controls a position of the second optical lens 40. The microcontroller 60 is coupled to the image sensor 20, the switching mechanism 50, and the infrared laser module 10. In the first embodiment of the present disclosure, a focal length of the first optical lens 30 may be larger than a focal length of the second optical lens 40, and a field-of-view (FOV) of the first optical lens 30 may be smaller than a FOV of the second optical lens 40. The first optical lens 30 may be a narrow-angle lens, which has a characteristic of a long focal length. The second optical lens 40 may be a wide-angle lens, which has a characteristic of a short focal length. In addition, the focal length of the first optical lens 30 may be between 2 meters and 30 meters, and the focal length of the second optical lens 40 may be between 15 centimeters and 3 meters or between 70 centimeters and 4 meters. The focal length of the first optical lens 30 and the focal length of the second optical lens 40 may partially overlap. Besides the partial overlap, the focal length of the first optical lens 30 is larger than the focal length of the second optical lens 40.

Further, the infrared laser may have a single luminous angle (or call as field of illumination, FoI), and can cover both narrow-angle lens and wide-angle lens at the same time. Or the infrared laser can provide two sets of lasers with narrow-angle and wide-angle emitting light sources respectively. In the first embodiment of the present disclosure, the infrared laser module 10 may include a first light-emitting unit 11 and a second light-emitting unit 12. The first light-emitting unit 11 outputs at least part of the infrared laser when the second optical lens 40 is not above the first optical lens 30. The second light-emitting unit 12 outputs at least part of the infrared laser when the second optical lens 40 is above the first optical lens 30. In the first embodiment of the present disclosure, an output wavelength of the first light-emitting unit 11 and an output wavelength of the second light-emitting unit 12 of the infrared laser module 10 may be between 800 nanometers (nm) and 1350 nanometers (nm). Further, both the first light-emitting unit 11 and the second light-emitting unit 12 can be integrated with a diffusion sheet (not shown in figures) in a light-emitting direction thereof, and the diffusion sheet can be adjusted according to required light-emitting angle. In the first embodiment of the present disclosure, the first light-emitting unit 11 can be designed to be used in a narrow-angle telephoto mode (i.e., the image sensor 20 has only the first optical lens 30 on an optical path thereof). The second light-emitting unit 12 may be designed to be used in a wide-angle short-focus mode (i.e., the image sensor 20 has the first optical lens 30 and the second optical lens 40 simultaneously on the optical path thereof).

The switching mechanism 50 may include at least one of a stepper motor, a servo motor, and a linear actuator. The linear actuator may also include shape memory alloys (SMA). The SMA is a material that can remember its original shape. When the SMA is subjected to a limited degree of plastic deformation since the temperature is lower than a phase transition temperature, the SMA can be restored to its original shape before deformation by heating. This special phenomenon is called a shape memory effect (SME). In the first embodiment of the present disclosure, the switching mechanism 50 may include a shift lever 51, a pivot 52, and a motor 53. One end of the shift lever 51 is equipped with the second optical lens 40, and the other end of the shift lever 51 is equipped with the pivot 52. The shift lever 51 is driven by the motor 53 through the pivot 52 to further control whether a position of the second optical lens 40 is disposed on the first optical lens 30 or moved away from the first optical lens 30.

The microcontroller 60 can obtain a time-of-flight (ToF) data (not shown in the figure) including detecting depth information through a method of ToF applying the image sensor 20, so that the microcontroller 60 can obtain 3D state of an area to be measured. The microcontroller 60 can control a modulation frequency and a power of the infrared laser outputted from the infrared laser module 10 according to the ToF data. The modulation frequency needs to maintain a fixed multiplication ratio relationship with a frame rate of the image sensor 20 and a distance between the image sensor 20 and the area to be measured. Therefore, the infrared laser module 10 can simultaneously provide the modulation frequency of the infrared laser to the image sensor 20 as a depth distance.

As shown in FIG. 3 and FIG. 4, when the image sensor 20 has only the first optical lens 30 on an optical path thereof, the microcontroller 60 can control the first light-emitting unit 11 to output the infrared laser with a higher-power, so that a projection range on the area to be measured by the infrared laser can cover a range of the FoV of the first optical lens 30, thereby meeting a requirement of the narrow-angle telephoto mode.

As shown in FIG. 5 and FIG. 6, when the image sensor 20 has the first optical lens 30 and the second optical lens 40 simultaneously on the optical path thereof, the microcontroller 60 can control the second light-emitting unit 12 to output the infrared laser with a lower power, so that a projection range on the area to be measured by the infrared laser can cover a range of the FoV of a composite of the first optical lens 30 and the second optical lens 40, thereby meeting a requirement of the wide-angle short-focus mode. The combination of the first optical lens 30 and the second optical lens 40 aforementioned can change an optical path length and a focal length of the entire optical system, especially a FoV of the optical system is enlarged, so that lenses can still cover enough range at close distance.

Further, the microcontroller 60 may be an image process integrated circuit (IC) or an image sensor system on a chip (SoC). While the microcontroller 60 is performing the method of ToF, the switching mechanism 50 can be used to determine whether the first optical lens 30 or the second optical lens 40 is located on an optical axis of the image sensor 20, so that the microcontroller 60 can quickly know a distance between the image sensor 20 and the area to be measured. The microcontroller 60 can immediately control the position of the first optical lens 30 and the second optical lens 40 according to a distance between the image sensor 20 and a target continuously updated. The focal length and FOV of at least one of the first optical lens 30 and the second optical lens 40 can correctly correspond to the area to be measured, so that the image sensor 20 can obtain a complete (the FOV of image sensor 20 can cover the area to be measured) and clear (the distance between the image sensor 20 and the area to be measured matches the focal length of the image sensor 20) image.

In the first embodiment of the present disclosure, the optical switchable depth sensing camera may further include an upper housing 101, a middle housing 102, and a lower housing 103. The upper housing 101 provides a first through hole 111, a second through hole 121, and a third through hole 131. The first through hole 111 is used for allowing the pivot 52 to pass through, and a spear-shaped groove is formed around the first through hole 111 to limit a rotation range of the shift lever 51. The second through hole 121 is used for the first optical lens 30 to receive the infrared laser from outside the upper housing 101. The third through hole 131 is used for the infrared laser module 10 to output the infrared laser outside the upper housing 101. The middle housing 102 is sandwiched between the upper housing 101 and the lower housing 103, and is used to fix the infrared laser module 10, the image sensor 20, and the microcontroller 60. In the first embodiment of the present disclosure, the optical switchable depth sensing camera may further include a first connection port 104 and a second connection port 105. The first connection port 104 and the second connection port 105 can be used for power supply, data transmission, remote control, and other purposes.

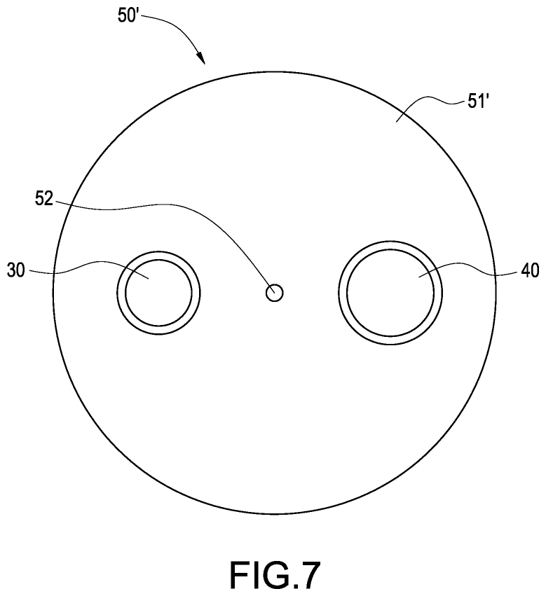

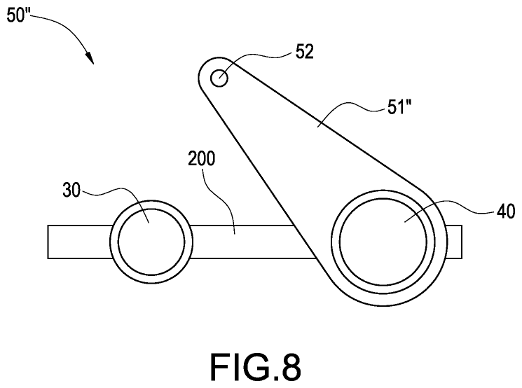

Please refer to FIG. 7 and FIG. 8, which are schematic diagrams of an optical module of the optical switchable depth sensing camera of the present disclosure. For the numbers of other components, please refer to the foregoing content, which will not be repeated here. Please refer to previous description for other reference numbers.

In the second embodiment of the present disclosure, which is substantially the same as the first embodiment aforementioned, except that the switching mechanism 51′, the first optical lens 30, and the second optical lens 40 constitute an optical module 50′, and the first optical lens 30 and the second optical lens 40 are movable relative to the image sensor 20.

As shown in FIG. 7, the switching mechanism 51′ is disc-shaped. The switching mechanism 51′ is coupled to the first optical lens 30 and the second optical lens 40, and the switching mechanism 51′ can be driven by the motor 53 through the pivot 52 to change whether a position of the first optical lens 30 and a position of the second optical lens 40 are above the image sensor 20.

As shown in FIG. 8, the difference from the aforementioned FIG. 7 is that the switching mechanism 51″, the first optical lens 30, and the second optical lens 40 constitute an optical module 50″, and the switching mechanism 51″ is only coupled to the second optical lens 40, but the first optical lens 30 is not fixed on the image sensor 20, and the first optical lens 30 and the second optical lens 40 are both movable relative to the image sensor 20. The switching mechanism 51″ can be driven by the motor 53 through the pivot 52. The first optical lens 30 can be disposed in a slide rail 200, and the first optical lens 30 can be pushed by the switching mechanism 51″ to change a position of the first optical lens 30 in the slide rail 200.

When using any optical switchable depth sensing camera of the present disclosure, the infrared laser module 10 outputs the infrared laser to an area to be measured, and the image sensor 20 receives the infrared laser reflected from the area to be measured through at least one of the first optical lens 30 and the second optical lens 40. Further, the microcontroller 60 can obtain the ToF data including detecting depth information through the method of ToF applying the image sensor 20, so that the microcontroller 60 can obtain 3D state of the area to be measured. And, while the microcontroller 60 is performing the method of ToF, the switching mechanism 50, 51′, and 51″ can be used to determine whether the first optical lens 30 or the second optical lens 40 is located on the optical axis of the image sensor 20, so that the microcontroller 60 can quickly know a distance between the image sensor 20 and the area to be measured. The microcontroller 60 can immediately control the position of the first optical lens 30 and the second optical lens 40 according to the distance continuously updated between the image sensor 20 and the target. The focal length and FOV of at least one of the first optical lens 30 and the second optical lens 40 can correctly correspond to the area to be measured, so that the image sensor 20 can obtain the complete (the FOV of image sensor 20 can cover the area to be measured) and clear (the distance between the image sensor 20 and the area to be measured matches the focal length of the image sensor 20) image.

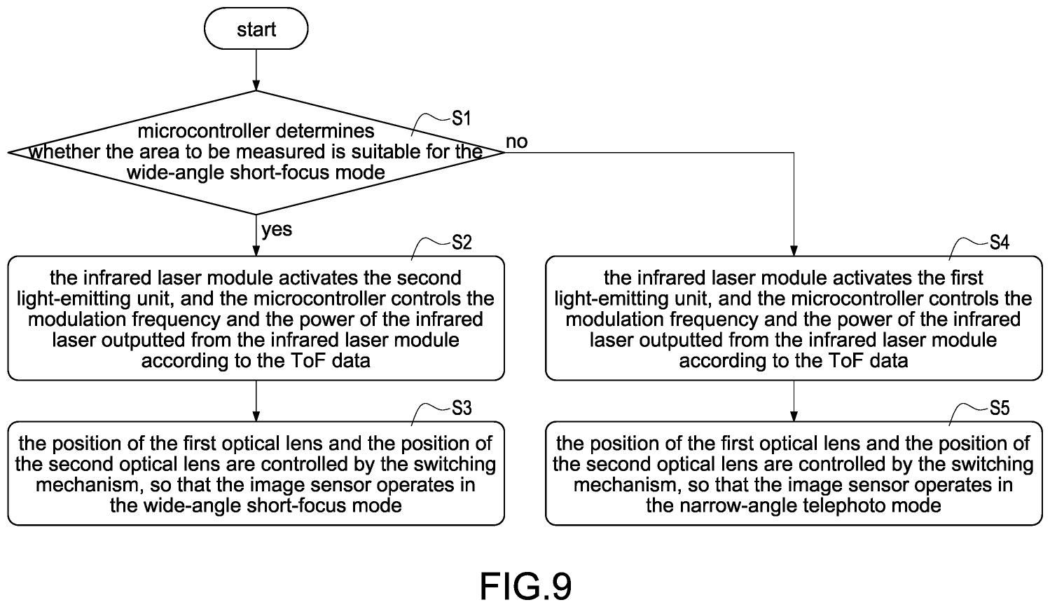

Please refer to FIG. 9, which is a schematic diagram of the determination flow of the switching mechanism 50, 51′, and 51″ of the optical switchable depth sensing camera of the present disclosure. Please refer to previous description for other reference numbers. When the microcontroller 60 is performing the method of ToF, the microcontroller 60 determines whether the area to be measured is suitable for the wide-angle short-focus mode (step S1). If the microcontroller 60 determines that the area to be measured is suitable for the wide-angle short-focus mode, the infrared laser module 10 activates the second light-emitting unit 12, and the microcontroller 60 controls the modulation frequency and the power of the infrared laser outputted from the infrared laser module 10 according to the ToF data (step S2). Afterward, the position of the first optical lens 30 and the position of the second optical lens 40 are controlled by the switching mechanism 50, 51′, and 51″, so that the image sensor 20 operates in the wide-angle short-focus mode (step S3). In addition, the microcontroller 60 can further combine the depth information of the wide-angle short-focus mode and the depth information of the narrow-angle telephoto mode during the method of ToF performed for 3D depth data fusion. The microcontroller 60 can overlay and convert several depth information measured and collected from different FOVs and distances according to a preset FOV calibration data table (not shown in the figure) to achieve an effect of full depth sensing.

If the microcontroller 60 determines that the area to be measured is not suitable for the wide-angle short-focus mode, the infrared laser module 10 activates the first light-emitting unit 11, and the microcontroller 60 controls the modulation frequency and the power of the infrared laser outputted from the infrared laser module 10 according to the ToF data (step S4). Afterward, the position of the first optical lens 30 and the position of the second optical lens 40 are controlled by the switching mechanism 50, 51′, and 51″, so that the image sensor 20 operates in the narrow-angle telephoto mode (step S5). In addition, the microcontroller 60 can further combine the depth information of the wide-angle short-focus mode and the depth information of the narrow-angle telephoto mode during the method of ToF performed for 3D depth data fusion. The microcontroller 60 can overlay and convert several depth information measured and collected from different FOVs and distances according to a preset FOV calibration data table (not shown in the figure) to achieve an effect of full depth sensing.

For this reason, the present disclosure can solve the related-art technical problems about non-stationary target with complex structures or moving relative to the image sensor is easy to cause out of the focal range or the FOV of the optical lens due to the target has moved too far, so as to achieve purposes of convenient to operate and to use.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that can be easily conceived by those skilled in the art in the field of the present disclosure can be covered by the following claims.

It should be understood that the structures, the proportions, the sizes, the number of components, and the like in the drawings are only used to cope with the contents disclosed in the specification for understanding and reading by those skilled in the art, and it is not intended to limit the conditions that can be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

What is claimed is:

1. An optical switchable depth sensing camera comprising:
an infrared laser module configured to output an infrared laser,
an image sensor configured to receive the infrared laser,
a first optical lens fixed on the image sensor,
a second optical lens removably disposed on the first optical lens,
a switching mechanism coupled to the second optical lens and configured to control a position of the second optical lens, and
a microcontroller coupled to the image sensor, the switching mechanism, and the infrared laser module.

2. The optical switchable depth sensing camera as claimed in claim 1, wherein, the infrared laser module comprises a first light-emitting unit and a second light-emitting unit, the first light-emitting unit is configured to output at least part of the infrared laser when the second optical lens is not above the first optical lens, and the second light-emitting unit is configured to output at least part of the infrared laser when the second optical lens is above the first optical lens.

3. The optical switchable depth sensing camera as claimed in claim 1, wherein, the microcontroller is configured to obtain a time-of-flight (ToF) data through the image sensor, the microcontroller is configured to control a modulation frequency and a power of the infrared laser outputted from the infrared laser module according to the ToF data.

4. The optical switchable depth sensing camera as claimed in claim 1, wherein, the switching mechanism comprises at least one of a stepping motor, a servo motor, and a linear actuator.

5. The optical switchable depth sensing camera as claimed in claim 1, wherein, a focal length of the first optical lens is larger than a focal length of the second optical lens, and a field-of-view (FOV) of the first optical lens is smaller than a FOV of the second optical lens.

6. The optical switchable depth sensing camera as claimed in claim 1, wherein, a focal length of the first optical lens is between 2 meters and 30 meters, and a focal length of the second optical lens is between 15 centimeters and 3 meters.

7. An optical switchable depth sensing camera comprising:
an optical module comprising a switching mechanism, a first optical lens, and a second optical lens, the switching mechanism coupled to at least one of the first optical lens and the second optical lens, and configured to control a position of the first optical lens and a position of the second optical lens,
an infrared laser module configured to output an infrared laser,
an image sensor configured to receive the infrared laser, and the first optical lens or the second optical lens removably disposed on the image sensor, and
a microcontroller coupled to the image sensor, the switching mechanism, and the infrared laser module.

8. The optical switchable depth sensing camera as claimed in claim 7, wherein, the infrared laser module comprises a first light-emitting unit and a second light-emitting unit, the first light-emitting unit is configured to output at least part of the infrared laser when the first optical lens is above the image sensor, and the second light-emitting unit is configured to output at least part of the infrared laser when the second optical lens is above the image sensor.

9. The optical switchable depth sensing camera as claimed in claim 7, wherein, the microcontroller is configured to obtain a time-of-flight (ToF) data through the image sensor, the microcontroller is configured to control a modulation frequency and a power of the infrared laser outputted from the infrared laser module according to the ToF data.

10. The optical switchable depth sensing camera as claimed in claim 7, wherein, the switching mechanism comprises at least one of a stepping motor, a servo motor, and a linear actuator.

11. The optical switchable depth sensing camera as claimed in claim 7, wherein, a focal length of the first optical lens is larger than a focal length of the second optical lens, and a field-of-view (FOV) of the first optical lens is smaller than a FOV of the second optical lens.

12. The optical switchable depth sensing camera as claimed in claim 7, wherein, a focal length of the first optical lens is between 2 meters and 30 meters, and a focal length of the second optical lens is between 15 centimeters and 3 meters.
